(19) United States
(12) Patent Application Publication
(10) Pub. No.: US 2023/0290337 A1
(43) Pub. Date: Sep. 14, 2023

(54) METHOD FOR TRAINING SLOT TAGGING MODEL, COMPUTER-READABLE MEDIUM, SPEECH RECOGNITION APPARATUS AND ELECTRONIC DEVICE

(71) Applicants: Hyundai Motor Company, Seoul (KR); Kia Corporation, Seoul (KR)

(72) Inventors: Soo Jong Do, Seoul (KR); Mirye Lee, Seoul (KR); Cheoneum Park, Seongnam (KR); Seohyeong Jeong, Suwon (KR); Cheongjae Lee, Suwon (KR); Kyuyeol Han, Seongnam (KR)

(21) Appl. No.: 18/081,464

(22) Filed: Dec. 14, 2022

(30) Foreign Application Priority Data
Mar. 8, 2022 (KR) 10-2022-0029592

(51) Int. Cl. G10L 15/06; G06F 40/242; G06F 40/284; G06F 40/117; G06F 40/126; G10L 15/22; G10L 15/18; G06N 20/00

(52) U.S. Cl. CPC G10L 15/063; G06F 40/242; G06F 40/284; G06F 40/117; G06F 40/126; G10L 15/22; G10L 15/1815; G06N 20/00; G10L 2015/223

(57) ABSTRACT

A method for training a slot tagging model may, when an entity used for slot tagging is added, accurately perform slot tagging corresponding to the added entity only by adding new data to an external dictionary, without retraining, a computer-readable medium storing a program for performing the training method, a speech recognition apparatus providing a speech recognition service using the trained slot tagging model, and an electronic device used to provide the speech recognition service.

### CROSS-REFERENCE TO RELATED APPLICATION

This application claims under 35 U.S.C. § 119(a) the benefit of Korean Patent Application No. 10-2022-0029592, filed on Mar. 8, 2022, in the Korean Intellectual Property Office, the present disclosure of which is incorporated herein by reference in its entirety.

### BACKGROUND

### Technical Field

Embodiments of the present disclosure relate to a method for training a slot tagging model, a computer-readable medium storing a program for performing the method, a speech recognition apparatus providing a speech recognition service using the slot tagging model, and an electronic device used to provide the speech recognition service.

### Description of the Related Art

Spoken language understanding (SLU) technology may be capable of identifying what is intended by a user from a user's speech and providing a service corresponding to the identified user intention, and may be linked to a specific device to control the device and provide specific information according to a user intention.

To implement the SLU technology, it may be essential to perform slot tagging which extracts an intent from a user's speech and labels types of slots constituting the user's speech. A slot in an SLU field represents meaningful information related to an intent included in a user's speech.

Recently, by applying deep learning technology to SLU technology, the accuracy of intent extraction and slot tagging has been improved. A process of training a deep learning model in advance using training data may be required to apply deep learning technology. In particular, in slot tagging, accurate inference may not be performed when data not used for training may be input.

However, because retraining by adding training data may be costly, it may be very disadvantageous in terms of cost to retrain a deep learning model each time an entity used for slot tagging is added.

### SUMMARY

An embodiment of the present disclosure provides a method for training a slot tagging model that may, when an entity used for slot tagging is added, accurately perform slot tagging corresponding to the added entity only by adding new data to an external dictionary, without retraining, a computer-readable medium storing a program for performing the training method, a speech recognition apparatus providing a speech recognition service using the trained slot tagging model, and an electronic device used to provide the speech recognition service.

Additional embodiments of the present disclosure will be set forth in part in the description which follows and, in part, will be obvious from the description, or may be learned by practice of the present disclosure.

According to an embodiment of the present disclosure, there may be provided a method for training a slot tagging model, the method including: generating a first input sequence based on an input sentence; generating a second input sequence using dictionary information from an external dictionary; performing a first encoding on the first input sequence and the second input sequence; performing a second encoding on the second input sequence; merging a result of the first encoding and a result of the second encoding; and performing slot tagging on the input sentence based on a result of the merging.

The generating of the first input sequence may include dividing the input sentence in units of tokens to generate the first input sequence, and the generating of the second input sequence may include generating the second input sequence based on whether each of a plurality of tokens included in the first input sequence matches the dictionary information included in the external dictionary.

The method may further include performing embedding on the first input sequence; and performing embedding on the second input sequence.

The method may further include concatenating a first embedding vector, obtained by performing the embedding on the first input sequence, and a second embedding vector obtained by performing the embedding on the second input sequence.

The performing of the first encoding may include performing the first encoding on a concatenation embedding vector obtained by concatenating the first embedding vector and the second embedding vector, and the performing of the second encoding may include performing the second encoding on the second embedding vector.

The merging may include obtaining a third context vector by merging a first context vector obtained by the first encoding and a second context vector obtained by the second encoding.

The merging may include merging the first context vector and the second context vector using an addition method or an attention mechanism.

The method may further include calculating a loss value for a result of performing the slot tagging, and adjusting weights of the slot tagging model based on the calculated loss value.

According to an embodiment of the present disclosure, there may be provided a computer-readable medium storing a program for implementing a method for training a slot tagging model, the method including: generating a first input sequence based on an input sentence; generating a second input sequence using dictionary information included in an external dictionary; performing a first encoding on the first input sequence and the second input sequence; performing a second encoding on the second input sequence; merging a result of the first encoding and a result of the second encoding; and performing slot tagging on the input sentence based on a result of the merging.

The generating of the first input sequence may include dividing the input sentence in units of tokens to generate the first input sequence, and the generating of the second input sequence may include generating the second input sequence based on whether each of a plurality of tokens included in the first input sequence matches the dictionary information included in the external dictionary.

The method for training a slot tagging model may further include: performing embedding on the first input sequence; and performing embedding on the second input sequence.

The method for training a slot tagging model may further include: concatenating a first embedding vector, obtained by performing embedding on the first input sequence, and a second embedding vector obtained by performing embedding on the second input sequence.

The performing of the first encoding may include performing the first encoding on a concatenation embedding vector obtained by concatenating the first embedding vector and the second embedding vector, and the performing of the second encoding may include performing the second encoding on the second embedding vector.

The merging may include obtaining a third context vector by merging a first context vector obtained by the first encoding and a second context vector obtained by the second encoding.

The merging may include merging the first context vector and the second context vector using an addition method or an attention mechanism.

The method for training a slot tagging model may further include: calculating a loss value for a result of performing the slot tagging, and adjusting weights of the slot tagging model based on the calculated loss value.

According to an embodiment of the present disclosure, there may be provided a speech recognition apparatus including: a communication module configured to receive a voice command of a user; a language processing module configured to process the received voice command to classify an intent corresponding to the received voice command and perform slot tagging on the voice command; and a control module configured to generate a signal, required to provide a function intended by the user, based on an output of the language processing module, wherein a slot tagging model used to perform the slot tagging in the language processing module may include: an embedding layer configured to obtain a first embedding vector by embedding a first input sequence generated based on an input sentence, and a second embedding vector by embedding a second input sequence generated using dictionary information included in an external dictionary; a first encoding layer configured to perform a first encoding on a concatenation embedding vector obtained by concatenating the first embedding vector and the second embedding vector; a second encoding layer configured to perform a second encoding on the second embedding vector; a merge layer configured to obtain a third context vector by merging a first context vector obtained by the first encoding and a second context vector obtained by the second encoding; and an output layer configured to output a slot tagging result for the third context vector.

The speech recognition apparatus may further include a memory configured to store the external dictionary, wherein the external dictionary stored in the memory may be configured to be updated with new data added.

According to an embodiment of the present disclosure, there may be provided an electronic device including: a microphone to which a voice command of a user may be input; a communication module configured to transmit information about the input voice command to a speech recognition apparatus; and a controller configured to, when a signal corresponding to a processing result of the user's voice command may be received from the speech recognition apparatus, perform control according to the received signal, wherein a slot tagging model used to process the user's voice command in the speech recognition apparatus may include: an embedding layer configured to obtain a first embedding vector by embedding a first input sequence generated based on an input sentence, and a second embedding vector by embedding a second input sequence generated using dictionary information included in an external dictionary; a first encoding layer configured to perform a first encoding on a concatenation embedding vector obtained by concatenating the first embedding vector and the second embedding vector; a second encoding layer configured to perform a second encoding on the second embedding vector; a merge layer configured to obtain a third context vector by merging a first context vector obtained by the first encoding and a second context vector obtained by the second encoding; and an output layer configured to output a slot tagging result for the third context vector.

The external dictionary may be configured to be updated with new data added.

### BRIEF DESCRIPTION OF THE DRAWINGS

These and/or other embodiments of the present disclosure will become apparent and more readily appreciated from the following description of the embodiments, taken in conjunction with the accompanying drawings of which:

FIG. 1 is a diagram schematically illustrating characteristics of a training model trained based on a method according to an embodiment;

FIG. 2 is a block diagram illustrating an apparatus for training a slot tagging model according to an embodiment;

FIG. 3 is a diagram illustrating an example of an external dictionary used in an apparatus for training a slot tagging model according to an embodiment;

FIG. 4 is a block diagram illustrating operations of a pre-processing module of an apparatus for training a slot tagging model according to an embodiment;

FIG. 5 is a block diagram illustrating operations of a first pre-processing module of an apparatus for training a slot tagging model according to an embodiment;

FIG. 6 is a block diagram illustrating operations of a feature extraction module of an apparatus for training a slot tagging model according to an embodiment;

FIG. 7 is a diagram illustrating an example of a first input sequence and a second input sequence generated by an apparatus for training a slot tagging model according to an embodiment;

FIG. 8 is a block diagram illustrating layers included in a slot tagging model trained in a training module of an apparatus for training a slot tagging model according to an embodiment;

FIG. 9 is a diagram schematically illustrating a structure of a slot tagging model trained in a training module of an apparatus for training a slot tagging model according to an embodiment;

FIG. 10 is a flowchart illustrating a method for training a slot tagging model according to an embodiment;

FIG. 11 is a table illustrating information about data used for training for an experiment;

FIG. 12 is a table showing experiment results;

FIGS. 13 and 14 are tables illustrating example sentences showing slot tagging results using a training model trained according to a method and apparatus for training a slot tagging model according to an embodiment;

FIG. 15 is a diagram illustrating a speech recognition apparatus and an electronic device according to an embodiment; and

FIG. 16 is a block diagram illustrating operations of a speech recognition apparatus and an electronic device according to an embodiment.

### DETAILED DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

The embodiments set forth herein and illustrated in the configuration of the present disclosure may be only preferred embodiments, so it should be understood that they may be replaced with various equivalents and modifications at the time of the present disclosure.

Terminologies used herein are for the purpose of describing particular embodiments only and is not intended to limit the present disclosure.

It is to be understood that the singular forms are intended to include the plural forms as well, unless the context clearly dictates otherwise.

It will be further understood that the terms “include”, “comprise” and/or “have” when used in this specification, specify the presence of stated features, integers, steps, operations, elements, and/or components, but do not preclude the presence or addition of one or more other features, integers, steps, operations, elements, components, and/or groups thereof.

Further, the terms such as “part”, “—device”, “—block”, “—member”, “—module”, and the like may refer to a unit for processing at least one function or act. For example, the terms may refer to at least process processed by at least one hardware, such as field-programmable gate array (FPGA)/application specific integrated circuit (ASIC), software stored in memories or processors.

It will be understood that, although the terms first, second, etc. may be used herein to describe various elements, these elements should not be limited by these terms.

Reference numerals used for method steps are just used for convenience of explanation, but not to limit an order of the steps. Thus, unless the context clearly dictates otherwise, the written order may be practiced otherwise.

The term “at least one” used herein includes any and all combinations of the associated listed items. For example, it should be understood that the term “at least one of a, b, or c” may include only a, only b, only c, both a and b, both a and c, both b and c, or all of a, b and c.

Hereinafter, embodiments of the present disclosure may be described in detail with reference to the accompanying drawings.

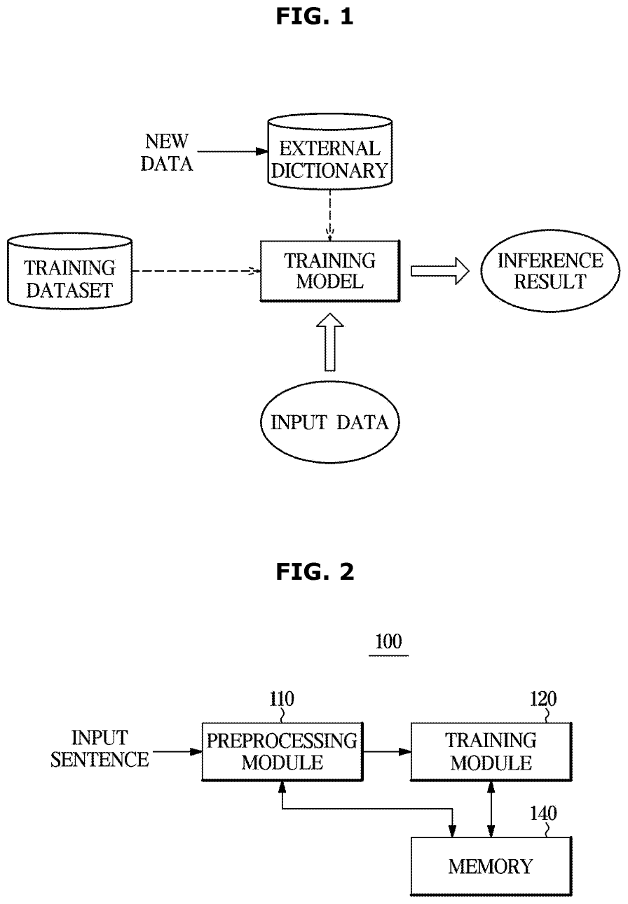

FIG. 1 is a diagram schematically illustrating characteristics of a training model trained based on a method according to an embodiment.

Referring to FIG. 1, training dataset may be used to train a training model. For example, the training dataset may include input data and output data, the input data may include a plurality of input sentences, and the output data may include a slot tagging result corresponding to each of the plurality of input sentences.

After the training of the training model is completed, in an inference stage, when input data may be input to the training model, an inference result corresponding thereto may be output.

Meanwhile, an external dictionary may store label information of an entity used for slotting tagging. In a training method according to an embodiment, information from the external dictionary may be learned together, when training the training model. Accordingly, when the dictionary may be updated with new data added, a slot tagging result corresponding to the new data may be inferred without retraining the training model. In the embodiment, the term ‘external dictionary’ may be used to mean that new data may be only added, without retraining, after training may be completed.

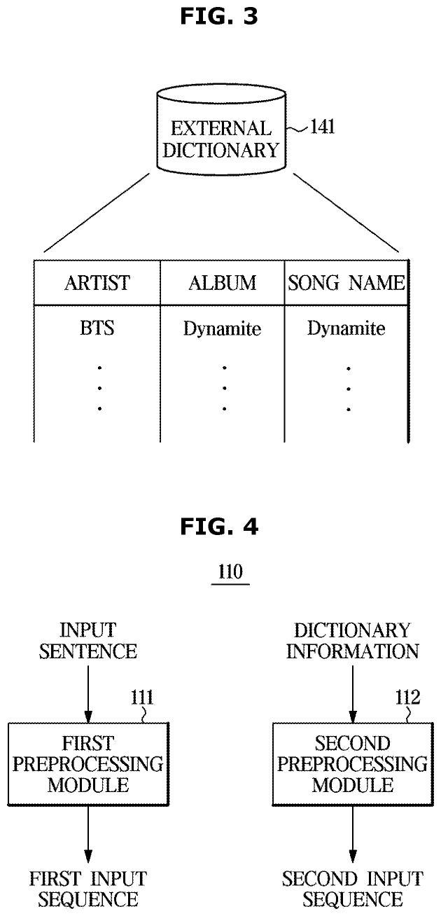

FIG. 2 is a block diagram illustrating an apparatus for training a slot tagging model according to an embodiment. FIG. 3 is a diagram illustrating an example of an external dictionary used in an apparatus for training a slot tagging model according to an embodiment.

Referring to FIG. 2, an apparatus for training a slot tagging model 100 according to an embodiment may include a pre-processing module 110 for pre-processing an input sentence, a training module 120 for training a slot tagging model and a memory 140 for storing an external dictionary.

The pre-processing module 110 may convert the input sentence in text form into a format that may be processed by a deep learning model, before the input sentence is input to the training module 120.

The training module 120 may store the deep learning model for slot tagging, i.e., the slot tagging model, and train the slot tagging model using training dataset.

When the training module 120 trains the slot tagging model, information from an external dictionary stored in the memory 140 may be learned together. Referring to FIG. 3, an album title and an artist name may be matched for each of a plurality of song names and stored in an external dictionary 141.

However, a table of FIG. 3 is only an example, and various information for slot tagging may be stored in the external dictionary. For example, a movie title, director's name, actors' names, etc., may be matched to each other and stored, or a restaurant name and a location thereof may be matched to each other and stored.

As such, by learning the information from the external dictionary together in a training process, an inference result corresponding to new data may be obtained by simply adding the new data to the external dictionary in the inference process after completion of training, without retraining.

The above-described pre-processing module 110 and the training module 120 may include at least one memory storing a program performing the aforementioned operations and at least one processor implementing a stored program.

However, constituent components such as the pre-processing module 110, the training module 120, and the like, may be distinguished by an operation, not by physical configuration. Accordingly, the constituent components may not be necessarily implemented with separate memories or processors, and at least a portion of constituent components may share a memory or processor.

Also, the memory 140 may not be necessarily physically separated from the pre-processing module 110 or the training module 120, and may be shared by the pre-processing module 110 or the training module 120.

For example, the apparatus for training a slot tagging model 100 according to an embodiment may be included in a server. After training the slot tagging model is completed, the apparatus for training a slot tagging model 100 may receive an input sentence or a voice command from an external electronic device communicating with the server, and transmit, to the external electronic device, a result corresponding to the voice command, based on a slot tagging result obtained using the trained slot tagging model, intent classification result, and the like.

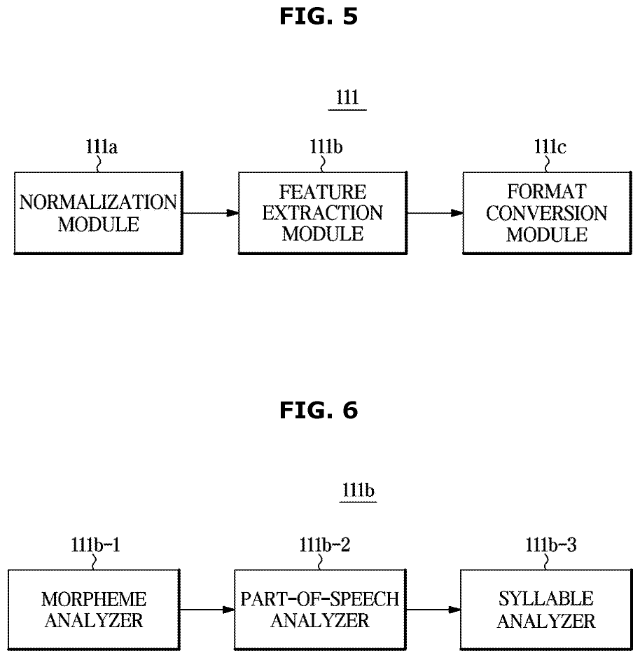

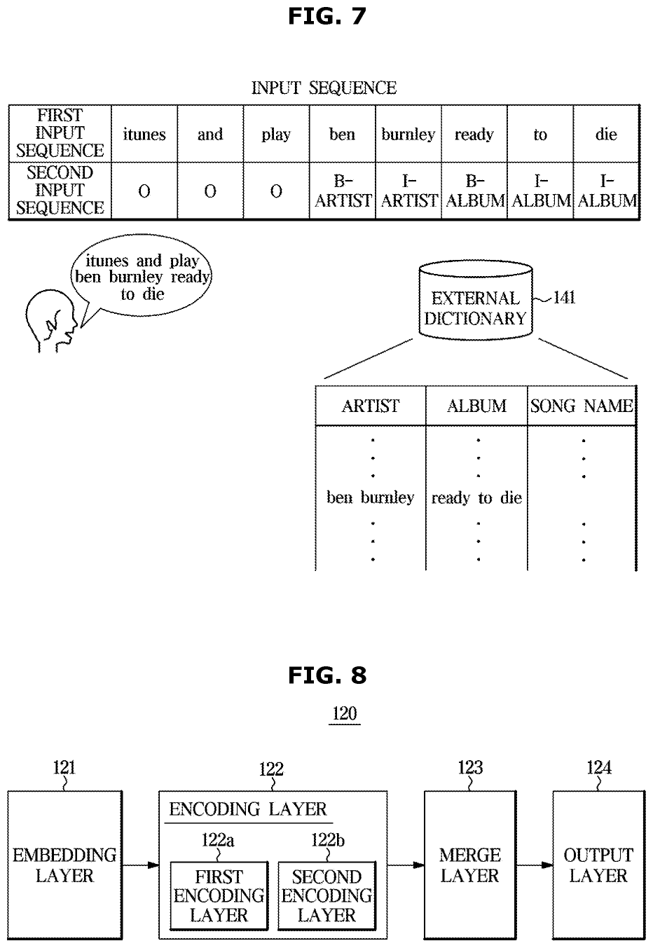

FIG. 4 is a block diagram illustrating operations of a pre-processing module of an apparatus for training a slot tagging model according to an embodiment. FIG. 5 is a block diagram illustrating operations of a first pre-processing module of an apparatus for training a slot tagging model according to an embodiment. FIG. 6 is a block diagram illustrating operations of a feature extraction module of an apparatus for training a slot tagging model according to an embodiment. FIG. 7 is a diagram illustrating an example of a first input sequence and a second input sequence generated by an apparatus for training a slot tagging model according to an embodiment.

Referring to FIG. 4, the pre-processing module 110 may include a first pre-processing module 111 which pre-processes an input sentence and generates a first input sequence, and a second pre-processing module 112 which generates a second input sequence using dictionary information stored in an external dictionary.

As described above, in a training process, a slot tagging model according to an embodiment may learn the dictionary information stored in the external dictionary together, and thus, when new data may be added to the external dictionary, an accurate inference result corresponding to the new data may be obtained without retraining. Accordingly, the pre-processing module 110 may pre-process the dictionary information stored in the external dictionary as well as the input sentence.

Regarding pre-processing of the input sentence, as shown in FIG. 5, the first pre-processing module 111 may include a normalization module 111a normalizing the input sentence, a feature extraction module 111b extracting a feature from the input sentence, and a format conversion module 111c converting a format of the input sentence.

The normalization module 111a may perform normalization to exclude meaningless data such as special characters, symbols, and the like, from the input sentence. It may be assumed that all input sentences processed by constituent components described below may be normalized input sentences.

The feature extraction module 111b may extract features from the normalized input sentence, and the format conversion module 111c may assign indexes to the input sentence based on the extracted feature.

Referring to FIG. 6, the feature extraction module 111b may include a morpheme analyzer 111b-1, a part-of-speech analyzer 111b-2, and a syllable analyzer 111b-3.

The morpheme analyzer 111b-1 may divide the input sentence in units of morphemes, and the part-of-speech analyzer 111b-2 may tag a part-of-speech for each morpheme by analyzing the part-of-speech for each morpheme.

The syllable analyzer 111b-3 may divide the input sentence in units of syllables. Because not only morphemes but also syllables may be used as features, an unknown word or infrequent word may be analyzed, thereby improving a performance of the training module 120. However, according to various embodiments of the present disclosure, syllable analysis may be omitted.

The format conversion module 111c may perform indexing on the input sentence based on a result of the feature extraction. Specifically, the format conversion module 111c may assign an index to each of a plurality of words or a plurality of features constituting the input sentence using a pre-defined dictionary. The index assigned in the format conversion process may indicate a position of a word in the dictionary. The indexes assigned to the input sentence by the format conversion module 111c may be used in an embedding process to be described later.

In the embodiment described below, the input sentence on which the pre-processing has been completed may be referred to as a first input sequence. The first input sequence may be processed in units of tokens. In the example, a token in units of morphemes may be used.

The second pre-processing module 112 may generate a dictionary sequence corresponding to the input sentence using dictionary information stored in the external dictionary 141. For example, the dictionary sequence may be generated in a form of BIO-tagged sequence having the same length as the input sequence. That is, the dictionary sequence may be generated based on whether each of the plurality of tokens included in the first input sequence matches the dictionary information stored in the external dictionary 141. In the embodiment described below, the dictionary sequence may be referred to as a second input sequence.

The second pre-processing module 112 uses only label information of the dictionary information and does not use a value, when generating the dictionary sequence in order to prevent lexical-dependency on training dataset.

Referring to an example of FIG. 7, when an input sentence may be “itunes and play ben burnley ready to die”, the second input sequence only includes information that a label corresponding to ‘ben burnley’ of the first input sequence may be an artist and information that a label corresponding to ‘ready to die’ of the first input sequence may be an album, and does not include the value itself, ‘ben burnley’ or ‘ready to die’.

That is, by adopting a method of training whether a corresponding singer exists in the dictionary, rather than a method of training letters of an entity such as a singer's name, etc., lexical-dependency on training dataset may be prevented.

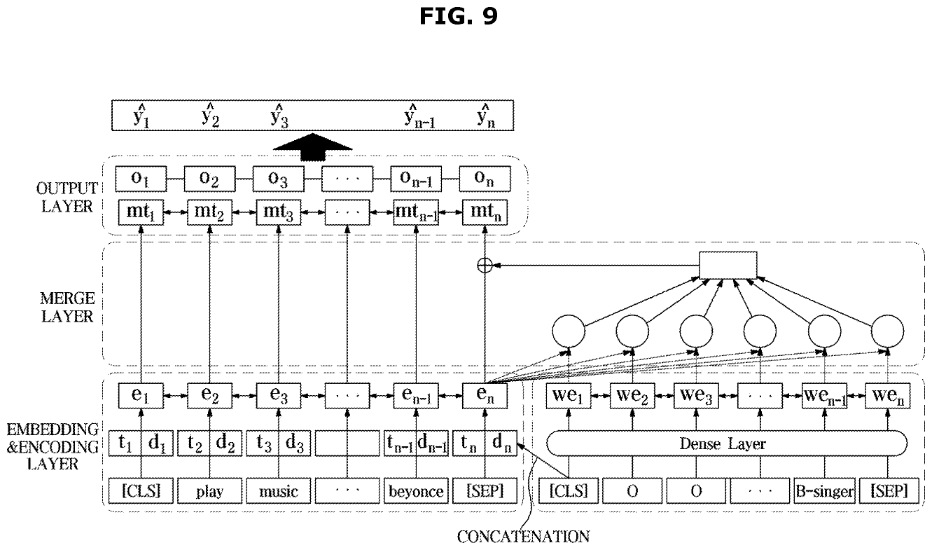

FIG. 8 is a block diagram illustrating layers included in a slot tagging model trained in a training module of an apparatus for training a slot tagging model according to an embodiment. FIG. 9 is a diagram schematically illustrating a structure of a slot tagging model trained in a training module of an apparatus for training a slot tagging model according to an embodiment.

Referring to FIGS. 8 and 9, a slot tagging model trained by the training module 120 may include an embedding layer 121, an encoding layer 122, a merge layer 123 and an output layer 124.

The embedding layer 121 performs embedding on tokens of an input sequence to vectorize the input sequence. For example, the embedding layer 121 may perform embedding by applying a one-hot vector encoding method.

Specifically, when k words exist, a k-dimensional 0 vector may be generated, and only a corresponding word may be represented with an index of 1. To this end, after removing redundant words, remaining words may be listed, each of the words may be converted into a one-hot vector, and each sentence may be reconstructed using the converted one-hot vector.

Also, a CLS token may be added to the input sequence input to the training module 120. Through an encoding process described below, the vector for the CLS token may imply a meaning of the input sentence.

Meanwhile, when the feature extraction module 111b extracts not only morpheme-unit features but also syllable-unit features, the syllable-unit features may also be input to the embedding layer 121 and used for character embedding.

Syllable-unit information provides information about similarity of a word and may be applicable to unknown or infrequent words which may not be included in a word dictionary, and thus use of both word-unit information and syllable-unit information may improve a performance of deep learning model.

Meanwhile, pre-training may be used for word embedding and character embedding. For example, for Korean, word embedding may be pre-trained by a neural network language model (NNLM), and character embedding may be pre-trained by GloVe (Pennington et al., 2014). For English, word embedding and character embedding may be pre-trained by FastText (Bojanowski et al., 2017). When pre-trained embedding may be used, the speed and performance of the deep learning model may be improved.

Also, the embedding layer 121 may generate a concatenation embedding vector by concatenating a first embedding vector generated by performing embedding on a first input sequence and a second embedding vector generated by performing embedding on a second input sequence.

The encoding layer 122 may encode tokens of the input sequence expressed as a vector through the embedding. The encoding layer 122 may include a first encoding layer 122a and a second encoding layer 122b. Here, the first encoding layer 122a may be for encoding a vector for a sequence in which dictionary information may be injected into the input sentence, i.e., the concatenation embedding vector, and the second encoding layer 122b may be for encoding a vector for a dictionary sequence, i.e., the second embedding vector.

Each of the first encoding layer 122a and the second encoding layer 122b may include a plurality of hidden layers.

For example, the first encoding layer 122a may encode the concatenation embedding vector using a Bi-directional long short term memory (LSTM), as shown in Equation 1 below.

eᵢ=Bi LSTM([tᵢ;dᵢ]) Equation 1
where eᵢ denotes an encoded vector for the concatenation embedding vector, ti denotes the first embedding vector, and dᵢ denotes the second embedding vector.

Meanwhile, because sequential information may not be included in the dictionary sequence, the second embedding vector may be encoded using a dense layer. For example, the second encoding layer 122b may encode the second embedding vector di using a one-stack dense layer, as shown in Equation 2 below.

weᵢ=Wᵢ*dᵢ+bᵢ Equation 2
where weᵢ denotes an encoded vector for the second embedding vector dᵢ, W denotes a weight matrix, and bᵢ denotes a bias term.

The merge layer 123 may obtain a third context vector by merging a first context vector ei which may be an output of the first encoding layer and a second context vector weᵢ which may be an output of the second encoding layer.

For example, the merge layer 123 may merge two context vectors using an addition method. The addition method may be expressed by [Equation 3] and [Equation 4] below.

ltᵢ=Wᵢ*eᵢ+bᵢ Equation 3

mtᵢ=Wᵢ*(ltᵢ+weᵢ)+bᵢ Equation 4

Here, W denotes a weight matrix, bᵢ denotes a bias term, and mtᵢ denotes the third context vector where two context vectors may be merged.

As another example, the merge layer 123 may also merge two context vectors using an attention mechanism where a softmax function may be applied.

According to an embodiment, both the information about the input sentence and the dictionary information may be learned through the above-described merging, thereby preventing a biased result, i.e., a result with insufficient accuracy, from being output.

The output layer 124 may output a slot tagging result using the third context vector obtained by merging as an input vector. For example, the output layer 124 may include a conditional random fields (CRF) model or a recurrent neural networks (RNN) model. Alternatively, the output layer 124 may use a Bi-directional LSTM-CRF model.

A structure when the output layer 124 uses the Bi-directional LSTM-CRF model may be illustrated in FIG. 9. Here, of =BiLSTM(mti) and yi denotes a probability of sequence labeling.

The output layer 124 may perform slot tagging using a B-I-O tag for sequence labeling. That is, the output layer 124 may label each token of the input sequence with a B-I-O tag. B may be assigned to a token where a slot begins, I may be assigned to a token included in a slot, and O may be assigned to a token which may not be included in a slot.

Also, although not illustrated, the training module 120 may further include a loss value calculator and a weight adjuster. The loss value calculator may calculate a loss value for the slot tagging result using a loss function. For example, the loss value calculator may use a cross-entropy as a loss function. The weight adjuster may adjust weights of hidden layers of the slot tagging model in a direction to minimize the calculated loss value.

By training the slot tagging model according to the above-described method, a slot tagging result corresponding to new data may be output only by adding the new data to the external dictionary 141 after completion of training, without retraining.

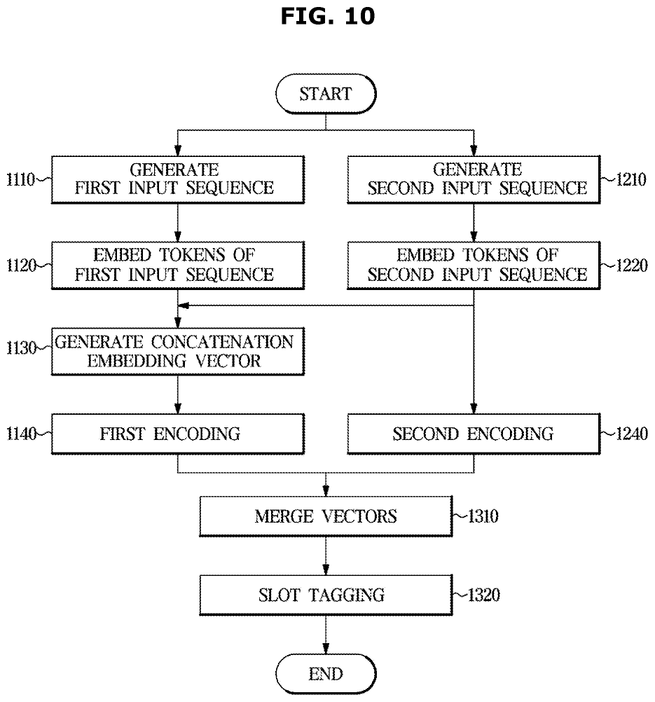

FIG. 10 is a flowchart illustrating a method for training a slot tagging model according to an embodiment.

The method for training a slot tagging model according to an embodiment may be performed by the above-described apparatus for training a slot tagging model 100. Accordingly, a description on the apparatus for training a slot tagging model may be equally applicable to the method for training a slot tagging model, even when not specifically described below. Also, a description on the method for training a slot tagging model may also be applied to the apparatus for training a slot tagging model, even when not specifically described below.

As shown in FIG. 10, when an input sentence may be input, the first pre-processing module 111 generates a first input sequence (1110) by pre-processing the input sentence, and the second pre-processing module 112 generates a second input sequence using dictionary information stored in an external dictionary (1210).

The embedding layer 121 embeds tokens of the first input sequence (1120) to vectorize the first input sequence, and embeds tokens of the second input sequence (1220) to vectorize the second input sequence.

Also, the embedding layer 121 may generate a concatenation embedding vector (1130) by concatenating a first embedding vector generated by performing embedding on the first input sequence and a second embedding vector generated by performing embedding on the second input sequence.

The first encoding layer 122a performs a first encoding, i.e., performs encoding on the concatenation embedding vector (1140), and the second encoding layer 122b performs a second encoding, i.e., performs encoding on the second embedding vector (1240).

For example, the first encoding layer 122a may encode the concatenation embedding vector using a Bi-directional LSTM, and the second encoding layer 122b may encode the second embedding vector using a dense layer.

The merge layer 123 obtains a third context vector by merging a first context vector ei which may be an output of the first encoding layer and a second context vector wei which may be an output of the second encoding layer (1310).

For example, the merging between the two context vectors may be performed by using an addition method or an attention mechanism.

The output layer 124 may output a slot tagging result by using the third context vector as an input vector (1320). For example, the output layer 124 may include a conditional random fields (CRF) model or a recurrent neural networks (RNN) model. Alternatively, the output layer 124 may use a Bi-directional LSTM-CRF model.

An experiment was carried out with respect to the slot tagging model trained according to the apparatus for training a slot tagging model 100 and the training method according to an embodiment and a slot tagging model trained according another method (hereinafter, referred to as a ‘comparison model’). Here, the comparison model may be trained by injecting dictionary information of an external dictionary into an embedding layer, and may be a model in which lexical information of dictionary information may be learned, regardless of whether information corresponding to tokens of an input sentence exists in the external dictionary.

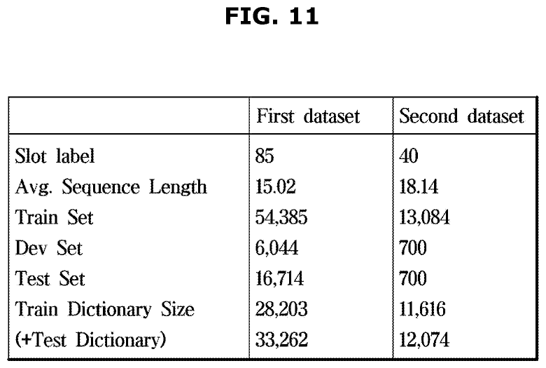

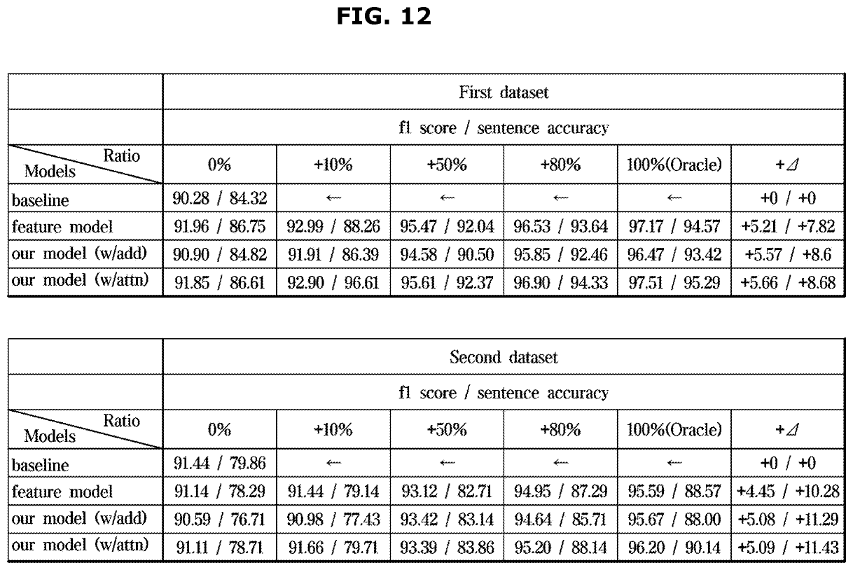

FIG. 11 is a table illustrating information about data used for training for an experiment. FIG. 12 is a table showing experiment results.

Referring to FIG. 11, a first dataset and a second dataset may be used. The first dataset may be a Korean dataset, and the second dataset may be an English dataset. The first dataset consists of texts for more than 70,000 speeches, mainly used as a command in AI assistants.

The second dataset may be mainly used in a slot tagging task, and may be transcripts corresponding to a set of speeches used in personal voice assistants.

Information about the number of slot labels of each dataset, an average sequence length, Train Set, Dev Set (development set), Test Set, Train Dictionary size, and the like, of each dataset may be shown in FIG. 11.

A character-level tokenizer was used for the first dataset, and a Bidirectional encoder representations from transformers (BERT, Reimers and Gurevych 2019) tokenizer was used for the second dataset.

Also, a hidden dimension was set to 128, an embedding dimension was set to 256, and a maximum input sequence length was set to 80.

In addition, labels capable of having various slot values were selected in order to confirm that the slot tagging model trained according to an embodiment may be robust to an unseen slot. The selected labels may be album, artist, city, country, entity_name, movie_name, object_name, playsit, playlist_owner, POI, restaurant_name, served_dish, state, track, and geographic_poi.

The slot tagging model and the comparison model were trained using Train Set and Dev Set. An evaluation environment was established by adding dictionary information that may be extracted from Test set, and the experiment was conducted by adjusting a scale of how much the dictionary information of the Test set has been used from 0% to 100%. 0% indicates that only the dictionary information of Test set was used and 100% indicates that an oracle dictionary in which the dictionary information of Test set may be all used was used.

As metrics of the experiment, sentence accuracy and f1 score were used, and the results thereof are shown in FIG. 12. Δ indicates a validity of the dictionary information as a score difference between 0% and 100%. In the experiment, a typical Bi-LSTM CRF model was used as a baseline.

In the table of FIG. 12, ‘feature model’ refers to the comparison model described above, ‘our model (w/add)’ refers to a model where an addition method may be used in the merge layer 123 among the slot tagging models trained according to an embodiment, and ‘our model (w/attn)’ refers to a model where an attention mechanism may be used in the merge layer 123 among the slot tagging models trained according to an embodiment.

Referring to FIG. 12, it may be confirmed that a sentence accuracy of the slot tagging model trained according to an embodiment is high. Also, it may be confirmed that a performance of the slot tagging model increases, as the dictionary information of the Test set increases. A performance of a baseline model is not changed, even when the dictionary information increases.

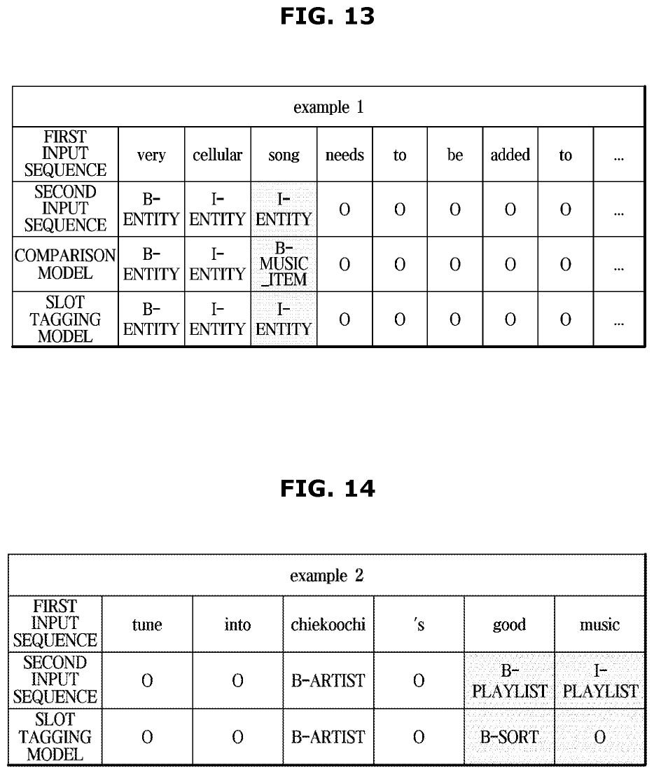

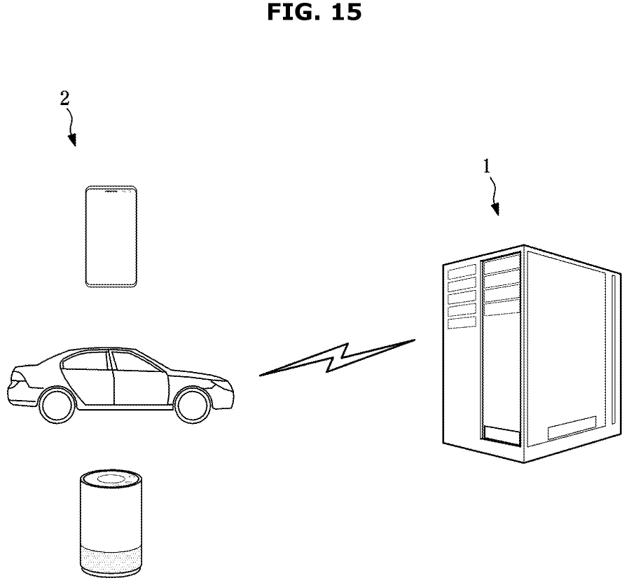

FIGS. 13 and 14 are tables illustrating example sentences showing slot tagging results using a training model trained according to a method and apparatus for training a slot tagging model according to an embodiment.

In an experiment of FIG. 13, when an input sentence is “very cellular song needs to be added to . . . ” and “very cellular” and “song” are stored in the external dictionary 141, slot tagging results of the slot tagging model trained according to an embodiment and a comparison model are compared. Results of the slot tagging model trained according to an embodiment are shown in a last row in the table.

Because a token of “song” was mainly tagged as MUSIC_ITEM in a training process using training dataset, as shown in FIG. 11, the comparison model tagged “song” as MUSIC_ITEM. In this case, however, “song” is a part of one slot, and thus “song” is required to be tagged as ENTITY. The slot tagging model trained according to an embodiment tagged “song” as ENTITY stored in the external dictionary 141.

In an experiment of FIG. 14, when an input sentence is “tune into chiekoochi's good music”, “chiekoochi” is stored as an artist in the external dictionary 141 and “good music” is stored as a playlist in the external dictionary 141, a slot tagging result of the slot tagging model trained according to an embodiment was obtained. Results of the slot tagging model trained according to an embodiment are shown in a last row in the table.

The slot tagging model trained according to an embodiment does not unconditionally output a tagging result based on the dictionary information, even when the dictionary information of the external dictionary 141 is included in the input sentence. Accordingly, even when “good music” is stored in the external dictionary 141 as a playlist, the slot tagging model trained according to an embodiment may tag “good” as SORT, not PLAYLIST, by considering context information based on the input sentence.

Hereinafter, a speech recognition apparatus using the slot tagging model trained according to the above-described embodiment, and a user's electronic device provided with a speech recognition result from the speech recognition apparatus are described.

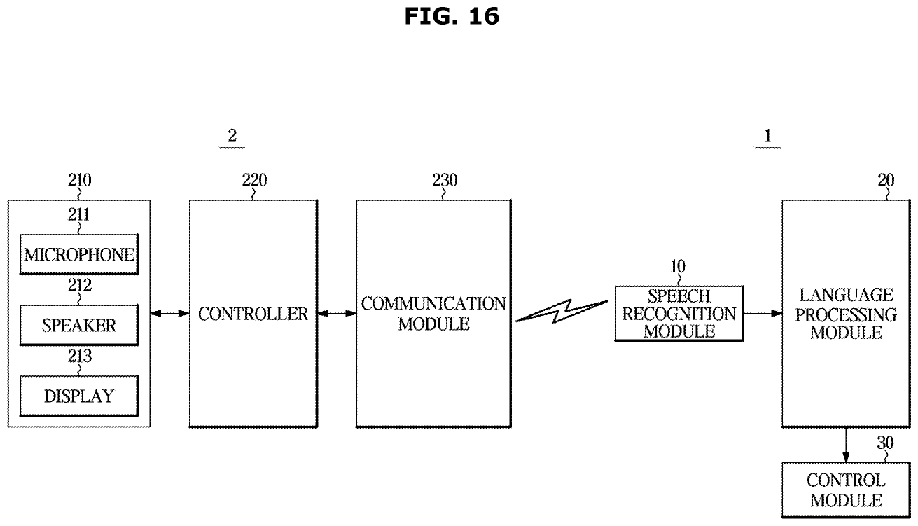

FIG. 15 is a diagram illustrating a speech recognition apparatus and an electronic device according to an embodiment. FIG. 16 is a block diagram illustrating operations of a speech recognition apparatus and an electronic device according to an embodiment.

Referring to FIG. 15, an electronic device 2 according to an embodiment may be implemented as a mobile device such as a smartphone, a table PC, a wearable device (smart watch, smart glasses, etc.), or be mounted on a vehicle, or implemented as various home appliances including an AI speaker or such function.

A user's speech input through the electronic device 2 may be transmitted to a speech recognition apparatus 1, and the speech recognition apparatus 1 may output a result corresponding to the user's speech by performing intent classification, slot tagging, and the like, on the transmitted speech. In this instance, the speech recognition apparatus 1 may perform slot tagging using a slot tagging model trained according to the above-described embodiment.

The speech recognition apparatus 1 may be implemented as a server, and the electronic device 2 may be equipped with the speech recognition apparatus 1 depending on a performance of the electronic device 2.

Referring to FIG. 16, the electronic device 2 includes a user interface such as a microphone 211, a speaker 212, and a display 2123, a communication module 230 communicating with the speech recognition apparatus 1, and a controller 220 controlling the electronic device 2.

A user may input a voice command to the microphone 211, and the controller 220 may transmit the input voice command to the speech recognition apparatus 1 through the communication module 230.

When a signal corresponding to a processing result of the voice command is received from the speech recognition apparatus 1, the controller 220 may perform control corresponding to the received signal. For example, when an intent extracted from the voice command corresponds to playing music, the controller 220 may control the speaker 212 to play music, and when an intent extracted from the voice command corresponds to a request for specific information, the controller 220 may control the speaker 212 or the display 213 to provide the requested information.

The speech recognition apparatus 1 may include a speech recognition module 10, a language processing module 20 and a control module 130. For example, the speech recognition apparatus 1 may be included in a server including a communication module that communicates with the electronic device 2. The speech recognition apparatus 1 may recognize a voice of the voice command received from the electronic device 2, perform language processing, and the like.

The speech recognition module 10 may be implemented with a speech to text (STT) engine, and perform conversion into text by applying a speech recognition algorithm to the user's speech.

For example, the speech recognition module 10 may extract feature vectors from the user's speech by applying a feature vector extraction method such as a cepstrum, a linear predictive coefficient (LPC), a Mel frequency cepstral coefficient (MFCC), a filter bank energy, or the like.

Also, a recognition result may be obtained by comparing extracted feature vectors and trained reference patterns. To this end, an acoustic model for modeling and comparing signal characteristics of voice or a language model for modeling a linguistic order of recognition vocabulary such as words or syllables may be used.

In addition, the speech recognition module 10 may convert a voice signal into the text based on learning where deep learning or machine learning is applied. In the embodiment, a way of converting the user's speech into the text by the speech recognition module 10 is not limited thereto, and a variety of speech recognition technologies may be applied to convert the voice command into the text.

The language processing module 20 may apply a spoken language understanding (SLU) technique to determine a user intention included in the text (hereinafter, “input sentence”). Specifically, the language processing module 20 may determine an intent corresponding to the input sentence and extract a slot from the input sentence, which may be referred to as intent classification, intent extraction, slot filling or slot tagging.

The language processing module 20 may use a pre-trained deep learning model for intent classification and slot tagging. In particular, the language processing module 20 may use a slot tagging model trained according to the above-described embodiment for slot tagging. Accordingly, an accurate slot tagging result may be provided only by adding new data to an external dictionary, used for slot tagging, without additional training.

A method of performing slot tagging on the input sentence using the slot tagging model trained according to the above-described embodiment may be the same as that shown in FIG. 10. That is, a slot tagging result may be output according to the operations shown in FIG. 10, except that the input sentence input to the slot tagging model is an input sentence corresponding to the user's voice command, not training dataset, and except that the processes of calculating a loss value and adjusting weights after slot tagging are omitted.

The control module 30 may generate a signal required to provide a function intended by the user based on an output of the language processing module 20, and transmit to the electronic device 2.

For example, when an intent corresponding to the user's voice command may be a control of the electronic device 2, a control signal for performing a control corresponding to the intent may be generated and output.

Alternatively, when an intent corresponding to the user's voice command is playing music, a signal for playing music may be generated and output, and when an intent corresponding to the user's voice command is a request for specific information, a signal for providing the specific information may be generated and output.

The above-described speech recognition apparatus 1 may be implemented by at least one memory storing a program performing the aforementioned operations and at least one processor implementing a stored program. Accordingly, a program implementing the slot tagging model trained according to the above embodiment and an external dictionary may be stored in the at least one memory of the speech recognition apparatus 1.

Here, the external dictionary stored in the memory may be updated with new data added, and the speech recognition apparatus 1 may obtain a slot tagging result corresponding to the new data, without retraining.

The constituent components of the speech recognition apparatus 1 shown in FIG. 16 may be divided based on their operation or function, and all or a portion of the constituent components may share a memory or processor. That is, the speech recognition module 10, the language processing module 20 and the control module 30 may not be necessarily physically separated.

As may be apparent from the above, according to the embodiments of the present disclosure, when an entity used for slot tagging may be added, slot tagging corresponding to the added entity may be accurately performed only by adding new data to an external dictionary, without retraining.

Meanwhile, embodiments may be stored in the form of a recording medium storing computer-executable instructions. The instructions may be stored in the form of a program code, and when executed by a processor, the instructions may perform operations of the disclosed embodiments.

The recording medium may be implemented as a non-transitory computer-readable medium.

The computer-readable medium includes all kinds of recording media in which instructions which may be decoded by a computer may be stored of, for example, a read only memory (ROM), random access memory (RAM), magnetic tapes, magnetic disks, flash memories, optical recording medium, and the like.

Although embodiments have been described for illustrative purposes, those skilled in the art will appreciate that various modifications, additions and substitutions may be possible, without departing from the scope and spirit of the present disclosure. Therefore, embodiments have not been described for limiting purposes.

What is claimed is:

1. A method for training a slot tagging model, comprising:
generating a first input sequence based on an input sentence;
generating a second input sequence using dictionary information included in an external dictionary;
performing a first encoding on the first input sequence and the second input sequence;
performing a second encoding on the second input sequence;
merging a first result of the first encoding and a second result of the second encoding; and
performing slot tagging on the input sentence based on a result of the merging.

2. The method of claim 1, wherein the generating of the first input sequence comprises dividing the input sentence in units of tokens to generate the first input sequence, and
the generating of the second input sequence comprises generating the second input sequence based on whether each of a plurality of tokens included in the first input sequence matches the dictionary information included in the external dictionary.

3. The method of claim 1, further comprising:
performing embedding on the first input sequence; and
performing embedding on the second input sequence.

4. The method of claim 3, further comprising:
concatenating a first embedding vector, obtained by performing the embedding on the first input sequence, and a second embedding vector obtained by performing the embedding on the second input sequence.

5. The method of claim 4, wherein the performing of the first encoding comprises performing the first encoding on a concatenation embedding vector obtained by concatenating the first embedding vector and the second embedding vector, and
the performing of the second encoding comprises performing the second encoding on the second embedding vector.

6. The method of claim 5, wherein the merging comprises obtaining a third context vector by merging a first context vector obtained by the first encoding and a second context vector obtained by the second encoding.

7. The method of claim 6, wherein the merging comprises merging the first context vector and the second context vector using an addition method or an attention mechanism.

8. The method of claim 1, further comprising:
calculating a loss value for a result of performing the slot tagging, and adjusting weights of the slot tagging model based on the calculated loss value.

9. A computer-readable medium storing a program for implementing a method for training a slot tagging model, the method comprising:
generating a first input sequence based on an input sentence;
generating a second input sequence using dictionary information received from an external dictionary;
performing a first encoding on the first input sequence and the second input sequence;
performing a second encoding on the second input sequence;
merging a first result of the first encoding and a second result of the second encoding; and
performing slot tagging on the input sentence based on a result of the merging.

10. The computer-readable medium of claim 9, wherein the generating of the first input sequence comprises dividing the input sentence in units of tokens to generate the first input sequence, and
the generating of the second input sequence comprises generating the second input sequence based on whether each of a plurality of tokens included in the first input sequence matches the dictionary information included in the external dictionary.

11. The computer-readable medium of claim 9, wherein the method further comprises:
performing embedding on the first input sequence; and
performing embedding on the second input sequence.

12. The computer-readable medium of claim 11, wherein the method further comprises:
concatenating a first embedding vector, obtained by performing embedding on the first input sequence, and a second embedding vector obtained by performing embedding on the second input sequence.

13. The computer-readable medium of claim 12, wherein the performing of the first encoding comprises performing the first encoding on a concatenation embedding vector obtained by concatenating the first embedding vector and the second embedding vector, and
the performing of the second encoding comprises performing the second encoding on the second embedding vector.

14. The computer-readable medium of claim 13, wherein the merging comprises obtaining a third context vector by merging a first context vector obtained by the first encoding and a second context vector obtained by the second encoding.

15. The computer-readable medium of claim 14, wherein the merging comprises merging the first context vector and the second context vector using an addition method or an attention mechanism.

16. The computer-readable medium of claim 9, wherein the method further comprises:
calculating a loss value for a result of performing the slot tagging, and adjusting weights of the slot tagging model based on the calculated loss value.

17. A speech recognition apparatus, comprising:
a communication module configured to receive a voice command of a user;
a language processing module configured to process the received voice command to classify an intent corresponding to the received voice command and perform slot tagging on the voice command; and
a control module configured to generate a signal, required to provide a function intended by the user, based on an output of the language processing module,
wherein a slot tagging model used to perform the slot tagging in the language processing module comprises:
an embedding layer configured to obtain a first embedding vector by embedding a first input sequence generated based on an input sentence, and a second embedding vector by embedding a second input sequence generated using dictionary information received from an external dictionary;
a first encoding layer configured to perform a first encoding on a concatenation embedding vector obtained by concatenating the first embedding vector and the second embedding vector;
a second encoding layer configured to perform a second encoding on the second embedding vector;
a merge layer configured to obtain a third context vector by merging a first context vector obtained by the first encoding and a second context vector obtained by the second encoding; and
an output layer configured to output a slot tagging result for the third context vector.

18. The speech recognition apparatus of claim 17, further comprising:
a memory configured to store the external dictionary,
wherein the external dictionary stored in the memory is configured to be updated with new data added.

19. An electronic device, comprising:
a microphone configured to receive as an input voice command a voice command of a user;
a communication module configured to transmit information about the input voice command to a speech recognition apparatus; and
a controller configured to, when a received signal corresponding to a processing result of the input voice command is received from the speech recognition apparatus, perform control according to the received signal,
wherein a slot tagging model used to process the input voice command in the speech recognition apparatus comprises:
an embedding layer configured to obtain a first embedding vector by embedding a first input sequence generated based on an input sentence, and a second embedding vector by embedding a second input sequence generated using dictionary information included in an external dictionary;
a first encoding layer configured to perform a first encoding on a concatenation embedding vector obtained by concatenating the first embedding vector and the second embedding vector;
a second encoding layer configured to perform a second encoding on the second embedding vector;
a merge layer configured to obtain a third context vector by merging a first context vector obtained by the first encoding and a second context vector obtained by the second encoding; and
an output layer configured to output a slot tagging result for the third context vector.

20. The electronic device of claim 19, wherein the external dictionary is configured to be updated with new data added.
